(19) United States
(12) Patent Application Publication
(10) Pub. No.: US 2026/0099065 A1
(43) Pub. Date: Apr. 9, 2026

(54) MULTIFOCAL LENS

(71) Applicant: Werner FIALA, Wien (AT)

(72) Inventors: Werner FIALA, Wien (AT); Johann PINGITZER, Schattendorf (AT)

(73) Assignee: Werner FIALA, Wien (AT)

(21) Appl. No.: 19/112,383

(22) PCT Filed: Aug. 2, 2023
(86) PCT No.: PCT/EP2023/071418

§ 371 Date: Mar. 17, 2025

(30) Foreign Application Priority Data
Sep. 26, 2022 (EP) 22197622.8

(51) Int. Cl. G02C 7/06

(52) U.S. Cl. CPC G02C 7/06

(57) ABSTRACT

A multifocal lens with at least three main refractive powers has a plurality of concentric annular main zones adjacent to each other. Each main zone is divided into an inner and an outer annular subzone of different refractive power. The lens is free of geometrical steps between all subzones, the refractive powers of all inner subzones are equal to each other, and the refractive powers of all outer subzones are equal to each other. Moreover, all inner and outer subzones share their respective main zone in an equal area ratio which is in a range of 30:70 to 70:30.

### CROSS-REFERENCE TO RELATED APPLICATIONS

This application is a National Phase application of International Application No. PCT/EP2023/071418 filed Aug. 2, 2023, which claims priority to the European Patent Application No. 22 197 622.8 filed Sep. 26, 2022, the disclosures of which are incorporated herein by reference.

### TECHNICAL FIELD

The present disclosed subject matter relates to a multifocal lens, in particular to a multifocal lens with at least three main refractive powers. The lens has a plurality of concentric annular main zones, each adjacent to the other, each of which is divided into an inner and an outer annular subzone of different refractive power, the lens being free of geometrical steps between all subzones.

### BACKGROUND

Such lenses are often used as ophthalmic lenses, e.g. as contact lenses, intraocular lenses (IOLs), intracorneal lenses or spectacle lenses.

Trifocal lenses have been known for a long time. In the majority of cases, these are diffractive lenses with ring-shaped zones of equal area, so-called “Fresnel zones”, in which geometric steps are provided between the zones. In such trifocal lenses, the height of the steps is usually alternately different. FIG. 1 shows the through focus response (TFR) of such a lens with 28 zones, in which the steps between the annular zones of equal area are alternately high, so that the optical path length differences are 0.65·λ and 1.35·λ, wherein λ denotes a wavelength of light. However, such stages are complex to produce, which results in high manufacturing costs.

Furthermore, trifocal refractive-diffractive lenses are known in which the steps are replaced by so-called “phase subzones” of small area, the refractive powers of which differ substantially from the refractive powers of the other, so-called “phase main zones” and thereby achieve a corresponding optical path length difference between the phase main zones (e.g. EP 1 194 797 B1, EP 2 564 265 B1). Such trifocal lenses exhibit a complex refractive force profile from the inside to the outside and a varying course of the area ratios between the phase subzones and the phase main zones and are therefore generally complex to manufacture.

### BRIEF SUMMARY

The objective of the disclosed subject matter is to create a multifocal lens with at least three main refractive powers that is easy and economical to manufacture.

This objective is achieved with a multifocal lens of the type mentioned at the outset, which according to the disclosed subject matter is distinguished by the fact that the refractive powers of all inner subzones are in each case equal to one another and the refractive powers of all outer subzones are in each case equal to one another, and that all inner and outer subzones share their respective main zone in an equal area ratio, which is in the range from 30:70 to 70:30.

The basis of the disclosed subject matter is the explicit consideration of the interference phenomena between light from the different subzones or main zones. By combining the alternating subzone refractive powers and the special area ratios between inner and outer subzones, the disclosed subject matter creates a multifocal lens which may have three or more main refractive powers, at least one of which is diffractive. Due to the simple surface-profile course with alternating refractive powers of the subzones, with equal area ratios of the subzone pairs forming the main zones and without geometric steps, the multifocal lens of the disclosed subject matter is particularly easy and economical to manufacture. In addition, the lens according to the disclosed subject matter enables a variety of divisions of the light intensity into its main refractive powers, e.g. an even division for good vision at a distance, medium distance and close up.

In an optional embodiment, all main zones have the same area. As a result, the main zones have the area ratios of a Fresnel zone lens, which simplifies the generation of the at least one diffractive main refractive force by interference between the sub- and main zones. In an alternative embodiment, the areas of the main zones increase or decrease monotonically from the inside to the outside, whereby the individual main refractive powers may be given a dependence on an aperture size, e.g. a pinhole or the pupil of the eye.

The diffractive main refractive powers of the lens may be generated particularly easily for visible light if the area of each main zone is less than 2.2π mm², or less than π mm², e.g., less than 2π/3 mm².

In a particularly favourable embodiment in terms of manufacturing technology, the aforementioned area ratio is optionally in the range of 40:60 to 60:40, e.g., 50:50.

The lens may have any number of main zones, e.g. more than 50 or more than 100. If the lens has 5 to 50 main zones, e.g. 10 to 20 main zones, its surface profile may be kept simple, while at the same time its at least one main diffractive power may be formed by light diffraction at the sub- and main zones with a sharp focus.

In a further optional embodiment, the lens has a far refractive power, a middle refractive power and a near refractive power as its main refractive powers, with the difference between the near refractive power and the far refractive power being in the range of 1 to 6 dioptres, optionally in the range of 2.0 to 4.5 dioptres. In this way, close and distant objects may be focussed well when the lens is used, in particular as an IOL. If, in addition, the difference between the middle refractive power and the far refractive power is in the range of 1.4 to 2 dioptres, optionally in the range of 1.6 to 1.8 dioptres, intermediate objects may also be focussed well.

In principle, the lens could have one or two main refractive powers which coincides/coincide with the refractive power of the inner and/or outer subzones. In an advantageous embodiment, all subzones in combination form a diffraction grating that generates the at least three main refractive powers of the lens by diffraction. As a result, none of the main refractive powers of the lens coincides with any of the refractive powers of its subzones and the main refractive powers may be determined by considering purely the interference phenomena between light from different subzones or main zones.

In a favourable combination of the latter two embodiments, the far refractive power may be generated by the negative first diffraction order (also called “diffraction order”) of the lens. While the use of this diffraction order for the remote refractive power is conventionally discouraged due to its chromatic longitudinal aberration, it has now been recognised for the first time that this same chromatic longitudinal aberration may be used advantageously to simulate or compensate for the refractive chromatic aberration present in the human or animal eye lens. In particular, the negative first diffraction order of the lens for light between 450 nm and 650 nm may have a diffractive longitudinal chromatic aberration which is in the range from 0.1 to 1.2 dioptres, optionally in the range from 0.3 to 0.7 dioptres, e.g. in the range from 0.35 to 0.55 dioptres.

In an advantageous embodiment of the lens, in particular as an IOL, the refractive power of the inner subzones or the refractive power of the outer subzones is in the range from −2.5 to 2.5 dioptres around the smallest of the main refractive powers, optionally in the range from −2.0 to 2.0 dioptres around the smallest of the main refractive powers, whereby the main refractive powers of the lens may be in the range of the refractive power of the human eye lens. For the same purpose, in a further advantageous embodiment which may optionally be combined with this, the refractive power of the inner subzones or the refractive power of the outer subzones may lie in the range from −2.5 to 2.5 dioptres around the largest of the main refractive powers, optionally in the range from −2.0 to 2.0 dioptres around the largest of the main refractive powers.

The subzones may all be homogeneous. Alternatively, at least one inner or outer subzone may be divided into partial zones of which the averaged refractive powers correspond to the refractive power of the respective subzone. In this way, one or more subzones may, for example, have a discrete or continuous through focus response, which enables a variety of manufacturing options for the lens and a variety of available diffraction patterns.

### BRIEF DESCRIPTION OF THE DRAWINGS

The disclosed subject matter is explained in greater detail below with reference to the exemplary embodiments shown in the accompanying drawings. In the drawings:

FIG. 1 shows a through focus response (TFR), as obtained with a trifocal lens according to the prior art at a light wavelength of 550 nm, in an intensity-refractive power diagram;

FIG. 2 shows a first embodiment of a trifocal lens according to the disclosed subject matter in a half section normal to its axis A of rotational symmetry;

FIG. 3 shows a central detail III of the lens of FIG. 2 in a half section normal to the axis A with the x-axis spread for better recognisability;

FIG. 4 shows a through focus response as obtained with the lens of FIGS. 2 and 3 at a light wavelength of 550 nm in an intensity-refractive power diagram;

FIG. 5 shows a modulation transfer function (MTF), as obtained with the lens of FIGS. 2 and 3, in a contrast-line diagram;

FIG. 6 shows a through focus response, as obtained with an exemplary variant of the lens of FIGS. 2 and 3 at a light wavelength of 550 nm, in an intensity-refractive power diagram;

FIG. 7 shows a through focus response as obtained with a trifocal lens according to a second embodiment of the disclosed subject matter at a light wavelength of 550 nm in an intensity-refractive power diagram;

FIG. 8 shows a through focus response as obtained with a trifocal lens according to a third embodiment of the disclosed subject matter at a light wavelength of 550 nm in an intensity-refractive power diagram;

FIG. 9 shows a through focus response as obtained with the lens of FIGS. 2 and 3 for polychromatic light with wavelengths from 450 nm to 650 nm in an intensity-refractive power diagram;

FIGS. 10a and 10b show three through focus responses as obtained with trifocal lenses according to the disclosed subject matter, which differ in the area ratios of their successive main zones, at a light wavelength of 550 nm (FIG. 10a) or with polychromatic light with wavelengths of 450 nm to 650 nm (FIG. 10b), in each case in an intensity-refractive power diagram;

FIG. 11 shows the dependence of the refractive power of the human eye on the wavelength of light in a refractive power-wavelength diagram; and

FIG. 12 shows the diffractive longitudinal chromatic aberration using two through focus responses, as obtained with the lens of FIGS. 2 and 3 at light wavelengths of 450 nm and 650 nm, in an intensity-refractive power diagram.

### DETAILED DESCRIPTION

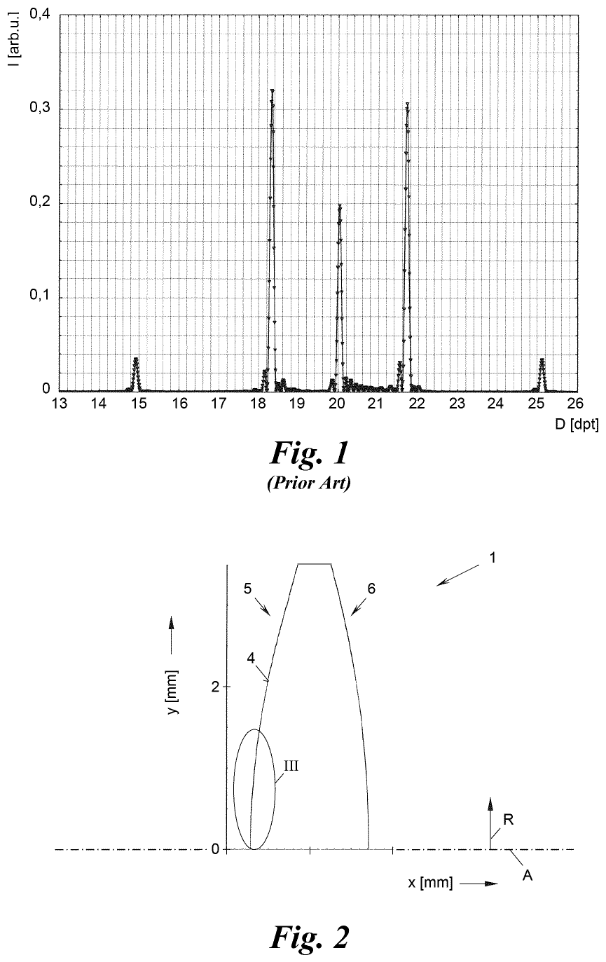

With regard to FIG. 1, which shows the prior art, reference is made to the introductory remarks.

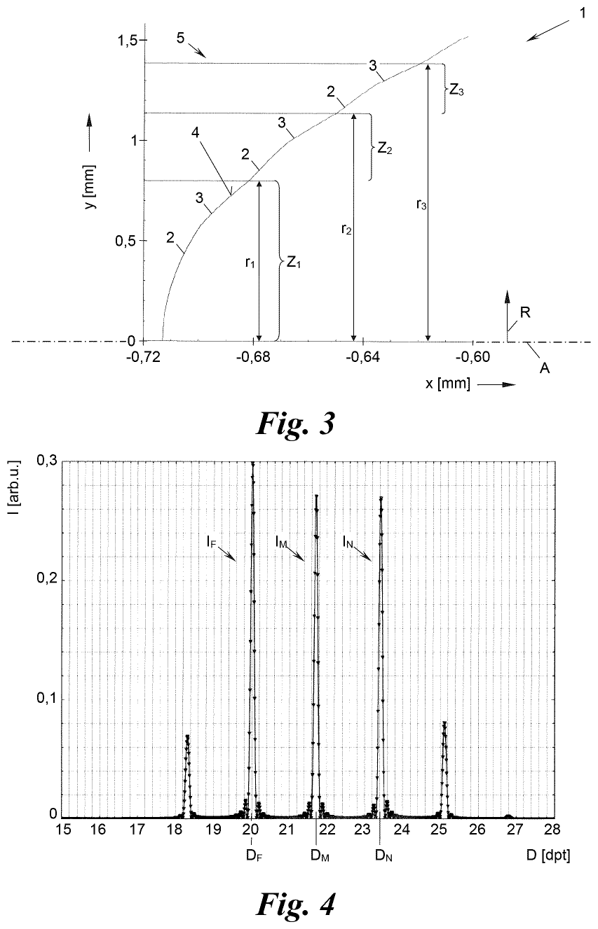

FIGS. 2 and 3 show a multifocal lens 1 according to the disclosed subject matter with at least three main refractive powers, in particular a far refractive power D_{F}, a middle refractive power D_{M} and a near refractive power D_{N} (FIG. 4) for vision of intermediate and distant, near objects, respectively. The lens 1 may be used, for example, as an ophthalmic lens, e.g. as a contact lens, intraocular lens (IOL), intracorneal lens or spectacle lens, or as an optical element, e.g. as a mirror, collecting or diverging lens. The lens 1 may be made of any material suitable for this purpose, e.g. glass, acrylic, silicone, hydrogel, polymethyl methacrylate (PMMA), etc.

The lens 1 has several (two, three or more) main zones Zᵢ (i=1, 2, . . . , I) concentric around its axis A of rotational symmetry, which are adjacent to each other. I.e., from the inside to the outside (in FIG. 3: in radial direction R), the second main zone Z₂ adjoins the first main zone Z₁ with its inner radius r₁ (measured from the optical axis A), the third main zone Z₃ adjoins the second main zone Z₂ with its inner radius r₂, etc., always without the interposition of further optical areas. The number I>1 of the main zones Zᵢ may be determined depending on the overall diameter of the lens 1 and the desired difference between near refractive power D_{N} and far refractive power D_{F} and is usually in the range from 5 to 50, in particular in the range from 10 to 20.

Each main zone Zᵢ is subdivided into an inner subzone 2 and an outer subzone 3, which have different refractive powers from one another, designated herein by the formula symbols “D₁” and “D₂”, respectively. The refractive powers D₁ of all inner subzones 2 and the refractive powers D₂ of all outer subzones 3 are the same in each case, i.e. each inner subzone 2 has the refractive power D₁ and each outer subzone 3 has the refractive power D₂.

Furthermore, in each of the main zones Zᵢ, the area ratio between its inner and outer subzones 2, 3 is equal and in the range from 30:70 to 70:30. If the area ratio of each inner subzone 2 to its main zone Zᵢ is denoted by p₁ and the area ratio of each outer subzone 3 to its main zone Z₁ is denoted by p₂, the inequality 30:70≤p₁:p₍₂₎≤70:30 therefore applies. In most embodiments, the area ratio p₁:p₂ is between 40:60 and 60:40, in some embodiments it is substantially 50:50.

As may be seen in FIG. 3, the lens 1 has no steps between all subzones 2, 3, i.e. neither between the main zones Zᵢ nor between their respective subzones 2, 3. The lens surface 4, which causes the multifocality of the lens 1, is therefore continuous.

At least one of the main refractive powers D_{F}, D_{M}, D_{N} Of the lens 1 is diffractive, i.e. generated by diffraction effects at the lens 1. The basis of the lens 1 disclosed here is thus the explicit consideration of the interference phenomena between light from the various subzones 2, 3 or main zones Zᵢ. For this purpose, the area of each main zone Zᵢ may be chosen to be smaller than 2.2n mm², for example, smaller than π mm² or smaller than 2π/3 mm². In some embodiments, all subzones 2, 3 in combination form a diffraction grating that generates all (here: three; alternatively: four or more) main refractive powers D_{F}, D_{M}, D_{N}, . . . of the lens 1. Then all main refractive powers D_{F}, D_{M}, D_{N}, . . . of the lens 1 are diffractive and the refractive powers D₁, D₂ in the subzones 2, 3 do not coincide with any of the resulting main refractive powers D_{F}, D_{M}, D_{N}, . . . of the multifocal lens 1 in most embodiments.

In the exemplary embodiment of the lens 1 shown in FIGS. 2 and 3, this is an intraocular lens (IOL) with a refractive index of 1.458. The main refractive powers D_{F}, D_{M}, D_{N} of the lens 1 are 20, 21.7 and 23.4 dioptres, the inner subzones 2 have a refractive power D₁ of 19.8 dioptres and the outer subzones 3 have a refractive power D₂ of 23.8 dioptres. On the front side 5 of the lens 1 there is the lens surface 4 generating the multifocality with all subzones 2, 3. Alternatively or additionally, the back side 6 of the lens 1 may also have such a lens surface 4 with main and subzones Zᵢ, 2, 3. In one embodiment, the lens 1 is a toric lens, wherein the lens surface facing away from the lens surface 4 has the shape of a torus cap.

The different refractive powers D₁, D₂ present in the individual subzones 2, 3 are not visible in the scale drawing in FIG. 2. For this reason, a central detail III of the lens surface 4 is shown in FIG. 3 in such a way that the x-axis parallel to the optical axis A is stretched by a factor of 13.3 in order to clearly show the different curvatures in the individual main zones Zᵢ.

From the illustrations in FIGS. 2 and 3, it may be seen that the lens 1 disclosed here is easier to manufacture than, for example, a diffraction lens according to the prior art with steps between the individual zones. In particular, the lens 1 may in this way have continuous lens surfaces 4 on the front and/or rear side 5, 6.

In the exemplary embodiment shown in FIGS. 2 and 3 the lens 1 has fourteen main zones Zᵢ of equal area (i.e. Fresnel zones) at a diameter of 6.02 mm. The central main zone Z₁ has a diameter d₁=2r₁ of 1.6088 mm; the ring-shaped second main zone Z₂ adjoining this main zone Z₁ has an inner diameter d₁=2r₁ of 1.6088 mm and an outer diameter d₂=2r₂ of 1.6088\sqrt{2} mm; the third main zone Z₃ has an outer diameter d₃=2r₃ of 1.6088\sqrt{3} mm; and the i-th main zone Zᵢ has an inner diameter dᵢ₋₁=2rᵢ₋₁ of 1.6088 \sqrt{i−1} mm and an outer diameter dᵢ=2rᵢ of 1.6088\sqrt{i} mm. In the example considered, the area components p₁ of the inner subzones 2 each amount to 52.5% and the area components p₂ of the outer subzones 3 each amount to 47.5% of the area of the respective main zone Zᵢ.

The resulting through focus response (TFR) of the lens 1 is shown in FIG. 4 in a diagram of the intensity I over the refractive power D. As may be seen from FIG. 4, the integrated intensities I_{F}, I_{M}, I_{N} in the three main refractive powers D_{F}=20 dioptres, D_{M}=21.7 dioptres and D_{N}=23.4 dioptres total 84% of the total integrated intensity, with the remaining 16% intensity being present in secondary maxima, which appear at 18.3 and 25.1 dioptres, respectively.

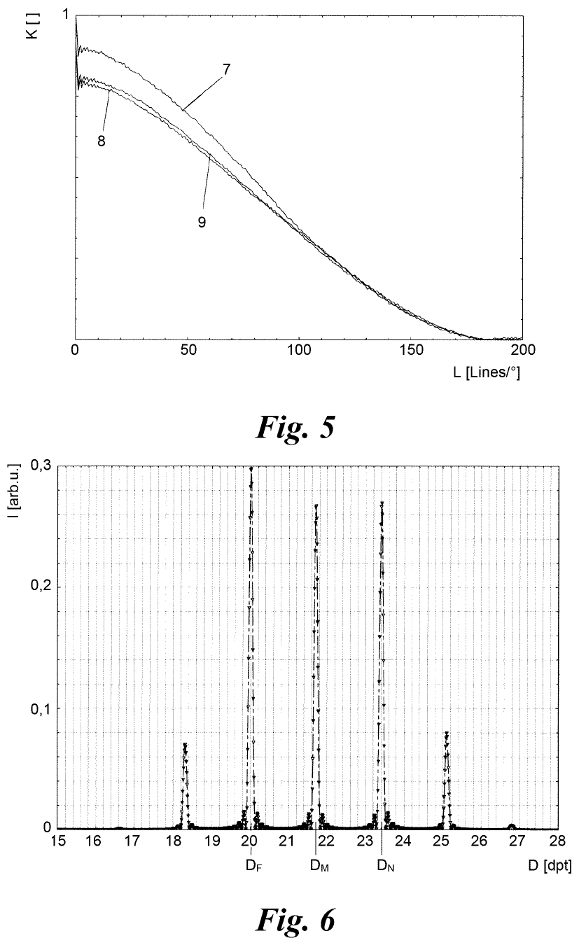

The modulation transfer function (MTF) is often used to assess the imaging properties. In FIG. 5, the MTFs in the three main refractive powers D_{F}, D_{M}, D_{N} for a light wavelength of 550 nm are shown for the lens 1 of FIGS. 2 and 3 as curves 7-9 of the contrast K over the line density L (lines per degree), namely as curve 7 for the far refractive power D_{F}, as curve 8 for the middle refractive power D_{M} and as curve 9 for the near refractive power D_{N}. For the lens 1 in question, the MTFs for the respective main refractive forces at the middle distance and the near distance (curves 8 and 9) are practically the same; the MTF for the far refractive force (curve 7) is slightly higher than for the other two main refractive forces.

It should be noted that a conventional diffractive trifocal lens with the same refractive power distance of 3.4 dioptres between near refractive power D_{N} and far refractive power D_{F} with the same diameter of 6.02 mm would require 28 Fresnel zones with 27 steps, i.e. discontinuities between these zones, in order to obtain the through focus response shown in FIG. 1. The lens 1 of the present disclosure, on the other hand, does not require any steps between the main zones Zᵢ or subzones 2, 3.

The following parameters were selected for the exemplary lens 1 in FIGS. 2 and 3: D₁=19.8 dioptres, D₂=23.8 dioptres, D_{F}=20 dioptres, D_{M}=21.7 dioptres, D_{N}=23.4 dioptres, p₁=0.525 and p₂=0.475. As may be seen, each of the resulting main refractive powers D_{F}, D_{M}, D_{N} of the lens 1 is not equal to the refractive powers D₁ and D₂ and may therefore be attributed to interference phenomena.

Furthermore, the relationship applies to the middle main refractive power D_{(M)}:

$${D}_{M} = {D}_{1} \cdot {p}_{1} + {D}_{2} \cdot {p}_{2} \qquad ( 1 )$$

The difference D_{N}−D_{F} does not depend on the choice of the refractive powers D₁ and D₂, but only on the areas of the main or subzones 2, 3 and may be determined, for example, for main zones 2 of the same area according to D_{N}−D_{F}=(2.2π mm)/(F·10³), where F denotes the area of the main zones in mm².

One of the refractive powers D₁ or D₂ may therefore be freely selected within certain limits. If, for example, D₁ is freely selected, the following applies:

$${D}_{1} \cdot {p}_{1} + {D}_{2} \cdot {p}_{2} = {D}_{M} = {D}_{1} \cdot {p}_{1} + {D}_{2} \cdot ( 1 - {p}_{1} ) \qquad ( 2 )$$

from which follows:

$${D}_{2} = ( {D}_{M} - {D}_{1} \cdot {p}_{1} ) / ( 1 - {p}_{1} ) . \qquad ( 3 )$$

If, for example, a value of 20.5 dioptres is taken for D₁ and D_{M} is again to be 21.7 dioptres, equation (3) gives the value 23.0263 dioptres for the area components p₁=0.525 and p₂=0.475 for D₂.

Instead of D₁, D₂ could also be specified and D₁ would then result from the relationship

$${D}_{1} = ( {D}_{M} - {D}_{2} \cdot {p}_{2} ) / ( 1 - {p}_{2} ) \qquad ( 4 )$$

As discussed, trifocality, for example, is achieved with the lens 1 by means of I main zones Zᵢ, each of which is subdivided into two subzones 2, 3, which have different refractive powers D₁, D₂. For the sake of completeness, it should be noted that the individual subzones 2, 3 could also be subdivided into further partial zones (not shown). If the refractive powers of all partial zones of a subzone 2 or 3 averaged over the subzone area correspond to the refractive power D₁ or D₂, the through focus response is in essence the same as if only a single refractive power D₁ or D₂ is used per subzone 2, 3. In general, the individual refractive forces D₁, D₂ of the subzones 2, 3 may each be replaced by any continuous refractive force distribution within the subzones 2, 3, as long as the mean value of this refractive force distribution formed over the subzone area corresponds to the required individual refractive force D₁ or D₂.

FIG. 6 shows the through focus response for a variant of the lens 1 in FIGS. 2 and 3, in which each subzone 2, 3 consists of two equal-area partial zones. The two partial zones of each inner subzone 2 have 19.5 and 20.1 dioptres, respectively, and the two partial zones of each outer subzone 3 have 23.4 and 24.2 dioptres, respectively. The mean value of each subzone 2 is therefore 19.8 dioptres and the mean value of each subzone 3 is 23.8 dioptres, the other parameters correspond to those of the lens 1 of FIGS. 2 and 3. As shown, the through focus responses of FIGS. 4 and 6 are practically identical. Alternatively, the subzones 2 and 3 may each have varying refractive power profiles, the respective mean values of which are given by D₁ and D₂.

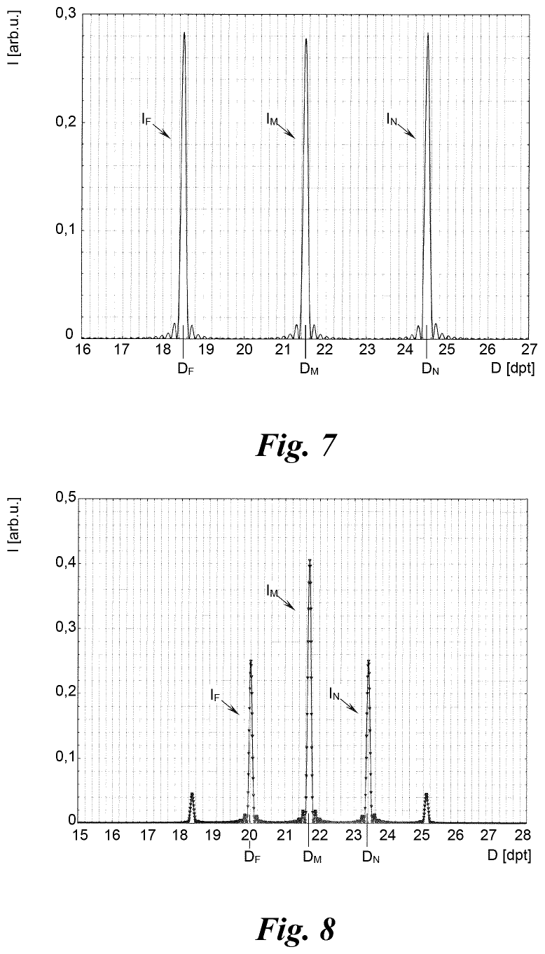

FIG. 7 shows the through focus response of a further embodiment of the lens 1 for monochromatic light of 550 nm, in which the area components of the subzones 2, 3 at each main zone Zᵢ are equal, i.e. p₁=p₂=0.5. The inner subzones 2 here have a refractive power D₁ of 18 dioptres and the outer subzones 3 have a refractive power D₂ of 25 dioptres. As shown, the lens 1 has three main refractive powers D_{F}, D_{M}, D_{N} of 18.5, 21.5 and dioptres, each with approximately equal 24.5 intensities I_{F}, I_{M}, I_{N}.

In the embodiments described so far, the resulting main refractive powers D_{F}, D_{M}, D_{N} of the lens 1 do not correspond to the refractive powers D₁, D₂ of the subzones. FIG. 8 shows the through focus response of an alternative embodiment in which the far refractive power D_{F} corresponds to the refractive power D₁ of the inner subzones 2 and the near refractive power D_{N} corresponds to the refractive power D₂ of the outer subzones 3, with both types of subzones 2, 3 having the same proportion of area in each main zone Zᵢ, i.e. p₁=p₂=0.5. As shown in FIG. 8, the middle refractive power D_{M} has an intensity Ix that is higher than the intensities I_{F}, I_{N} of the two other main refractive powers D_{F}, D_{N}.

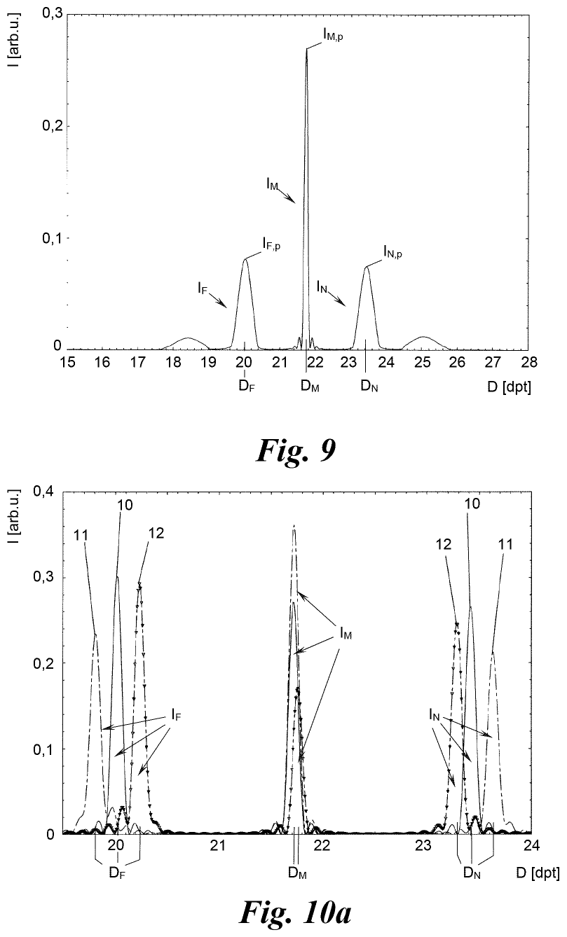

The operating principle of the lens 1 for monochromatic light has been explained so far. FIG. 9 shows the through focus response of the lens 1 in FIGS. 2 and 3 for polychromatic light, the spectrum of which extends from 450 to 650 nm. The far refractive power D_{F} of 20 dioptres corresponds to the negative first order of diffraction of the lens 1, the near refractive power D_{N} of 23.4 dioptres corresponds to the positive first order of diffraction, and the middle refractive power D_{M} of 21.7 dioptres corresponds to the zeroth order of diffraction. The positive and negative first diffraction orders each exhibit diffractive chromatic aberration, as a result of which the peak intensities I_{F,p}, I_{N,p} in these diffraction orders for polychromatic light are smaller than the peak intensity I_{M,p} in the zeroth diffraction order. As may be inferred from FIG. 9, the integrated intensities I_{F}, I_{N}, I_{N} in the individual main refractive powers D_{F}, D_{M}, D_{N} are approximately the same, which means that the imaging qualities in the three main refractive powers D_{F}, D_{M}, D_{N} are comparable.

In the example shown, the lens 1 is made of a material that gives it a negligibly small refractive chromatic aberration, i.e. its refractive index is substantially independent of the wavelength of the light. Exemplary materials are glass, acrylic, silicone, hydrogel and PMMA. Alternatively, the lens 1 may be made of a different material.

The embodiments described so far have main zones Zᵢ of the same area, i.e. so-called Fresnel ring zones, wherein the following applies for the outer radius rᵢ of the i-th main zone Zᵢ:

$${r}_{1} = {r}_{1} \cdot {i}^{0.5} . \qquad ( 5 )$$

In such an embodiment of the lens 1, the individual main refractive powers D_{F}, D_{M}, D_{N} remain substantially independent of the optical pupil size, whether this is given, for example, by a pinhole diaphragm or by the pupil of an eye. However, it may also be desirable for the individual main refractive forces D_{F}, D_{M}, D_{N} to be dependent on the pupil size, which may be achieved, for example, by selecting the radii rᵢ according to

$${r}_{i} = {r}_{1} \cdot {i}^{z} with z \neq 0.5 \qquad ( 6 )$$

For example, it may be intended that the near refractive power D_{N} is slightly greater with a large pupil than with a small pupil. For this purpose, the main zones Zᵢ may have smaller areas with increasing distance from the optical axis A (z<0.5). Conversely, if, for example, the near refractive power D_{N} is to decrease with increasing pupil size, the main zones Zᵢ may have larger areas with increasing distance from the optical axis A (z>0.5).

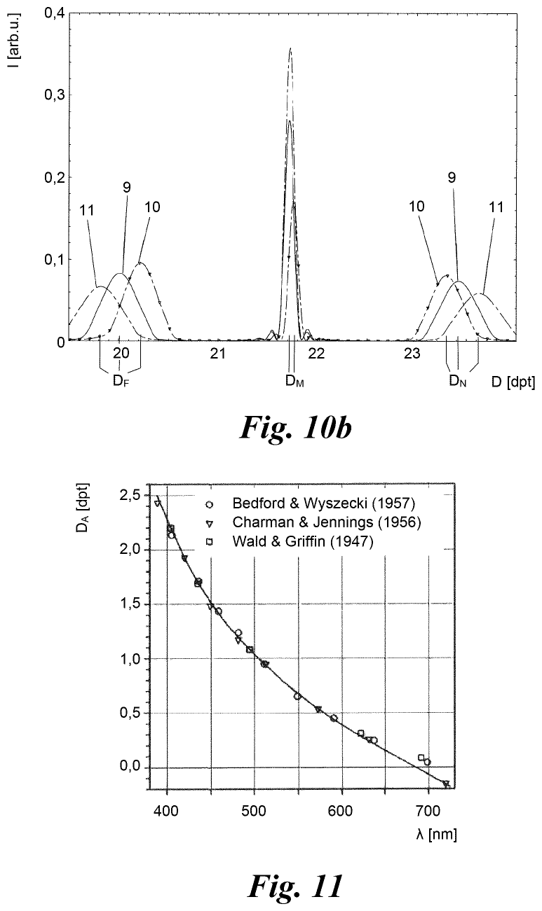

FIGS. 10a and 10b show through focus responses for different values of the parameter z for monochromatic light with a wavelength of 550 nm (FIG. 10a) and for polychromatic light with wavelengths of 450 nm to 650 nm (FIG. 10b), for a value z of 0.5 with solid lines 10, for a value z of 0.48 with dashed lines 11 and for a value z of 0.52 with lines 12 with triangles. As shown, the main refractive powers D_{F}, D_{M}, D_{N}, their associated intensities I_{F}, I_{M}, I_{N} and their respective maxima change with the parameter z; however, the sum of the intensities I_{F}, I_{M}, I_{N} does not.

Conventionally, in diffractive bifocal or trifocal lenses, it is considered advantageous to use the diffractive power of the zeroth order of diffraction as the refractive power D_{F}, since there is no diffractive chromatic aberration in the zeroth order of diffraction. However, in one embodiment of the lens 1 disclosed herein, the diffractive power of the negative first order of diffraction is now used as the far refractive power D_{F}, e.g. to mimic the chromatic aberration of the eye lens, as described below.

FIG. 11 shows the refractive power D_{A} of the human eye as a function of the wavelength λ of the light (according to: Charman W N, Jennings J A M (1976), “Objective Measurement of the longitudinal chromatic aberration of the human eye”, Vision Res. 16:999-1005). As FIG. 11 shows, the longitudinal chromatic aberration of the human eye between 450 nm and 650 nm is approximately 1.3 dioptres, wherein the refractive power for 450 nm (blue light) is greater than for 650 nm (red light). According to the standard work Bergmann-Schäfer: Optik, Verlag Walter de Gruyter, 1993, the refractive power of the entire human eye is 58.8 dioptres and that of the eye lens is 20.2 dioptres. Assuming that the chromatic aberrations of the entire eye and the eye lens therein are proportional to the respective refractive powers, the chromatic aberration of the eye lens may be estimated in terms of magnitude as 1.3·20.2/58.8=0.447≈0.45 dioptres, wherein blue light is refracted more strongly than red light.

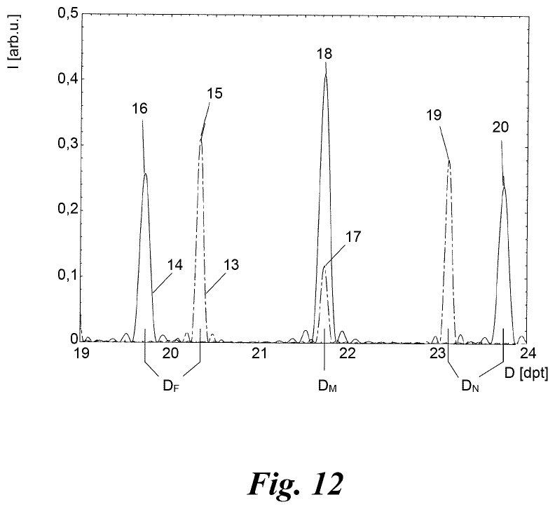

FIG. 12 shows the main refractive powers D_{F}, D_{M}, D_{N} of lens 1 of FIGS. 2 and 3 for the two wavelengths 450 nm (dashed curve 13) and 650 nm (solid curve 14). As may be inferred from FIG. 12, the diffractive longitudinal chromatic aberration in the negative first order of diffraction (for the refractive power D_{F}) is 0.51 dioptres (see the two left-hand peaks 15, 16 in FIG. 12) for the parameters selected as an example, a value which is close to the value given above for the eye lens. In the zeroth diffraction order (for the middle refractive power D_{M}), the diffractive longitudinal chromatic aberration of the lens 1 is zero (see the two centre peaks 17, 18 in FIG. 12), and in the positive first diffraction order (for the near refractive power D_{N}), the diffractive longitudinal chromatic aberration is −0.51 dioptres (see the two right peaks 19, 20 in FIG. 12), i.e. red light is refracted more strongly than blue light, which counteracts the chromatic aberration of the rest of the eye. This means that the lens 1 exhibits approximately the chromatic aberration of the eye lens for the far distance, no chromatic aberration for the middle distance and approximately the chromatic aberration of the eye lens with the opposite sign for the near distance.

The parameters of the lens 1 may be selected according to other estimates of the eye's own chromatic aberration or adapted to the individual (previously measured) eye lens of a patient. For example, the negative first order of diffraction of the lens for light between 450 nm and 650 nm could have a diffractive longitudinal aberration which is in the range of 0.1 to 1.2 dioptres, e.g. in the range of 0.3 to 0.7 dioptres, in particular—close to the value estimated above—in the range of 0.35 to 0.55 dioptres.

Of course, the refractive powers D₁, D₂ of the subzones 2, 3, their area components p₁, p₂ at their respective main zone Zᵢ and the associated main refractive powers DE, D_{M}, D_{N}, . . . of the lens 1 may deviate from the illustrated embodiments or several of the presented embodiments may be combined. For example, the difference between the near refractive power D_{N} and the far refractive power D_{F} may be in the range from 1 to 6 dioptres, e.g. in the range from 2.0 to 4.5 dioptres. For example, the difference between the middle refractive power D_{M} and the far refractive power D_{F} may be in the range from 1.4 to 2 dioptres, for example in the range from 1.6 to 1.8 dioptres. Furthermore, one of the refractive powers D₁ or D₂ of the subzones 2, 3 may lie, for example, in the range from −2.5 to 2.5 dioptres around the far refractive power D_{F}, in particular in the range from −2.0 to 2.0 dioptres; alternatively or additionally, the other of the refractive powers D₁ or D₂ of the subzones 2, 3 could, for example, be in the range of −2.5 to 2.5 dioptres around the near refractive power D_{N}, in particular in the range of −2.0 to 2.0 dioptres.

The disclosed subject matter is not limited to the embodiments presented, but includes all variants, modifications and combinations falling within the scope of the appended claims.

What is claimed is:

1. A multifocal lens having at least three main refractive powers, comprising a plurality of concentric annular main zones respectively adjacent to each other, each of which is divided into an inner and an outer annular subzone of different refractive power, and wherein the lens is free of geometrical steps between all subzones,
wherein the refractive powers of all inner subzones are in each case equal to one another and the refractive powers of all outer subzones are in each case equal to one another, and wherein all inner and outer subzones share their respective main zone in an equal area ratio, which is in a range from 30:70 to 70:30.

2. The multifocal lens according to claim 1, wherein all the main zones each have a same area.

3. The multifocal lens according to claim 1, wherein the areas of the main zones increase or decrease monotonically from inside to outside.

4. The multifocal lens according to claim 1, wherein the area of each main zone is less than 2.2π mm².

5. The multifocal lens according to claim 1, wherein said area ratio is in a range of 40:60 to 60:40.

6. The multifocal lens according to claim 1, wherein the lens has 5 to 50 main zones.

7. The multifocal lens according to claim 1, wherein the lens has as main refractive powers a far, a middle and a near refractive power, wherein a difference between the near refractive power and the far refractive power is in a range from 1 to 6 dioptres.

8. The multifocal lens according to claim 7, wherein a difference between the middle refractive power and the far refractive power is in a range from 1.4 to 2 dioptres.

9. The multifocal lens according to claim 1, wherein all subzones in combination form a diffraction grating which generates the at least three main refractive powers of the lens by diffraction.

10. The multifocal lens according to claim 7, wherein all subzones in combination form a diffraction grating which generates the at least three main refractive powers of the lens by diffraction, and wherein the far refractive power is generated by a negative first diffraction order of the lens.

11. The multifocal lens according to claim 10, wherein the negative first diffraction order of the lens for light between 450 nm and 650 nm has a diffractive longitudinal chromatic aberration which is in a range from 0.1 to 1.2 dioptres.

12. The multifocal lens according to claim 1, wherein the refractive power of the inner subzones or the refractive power of the outer subzones is in a range from −2.5 to 2.5 dioptres around the smallest of the main refractive powers.

13. The multifocal lens according to claim 1, wherein the refractive power of the inner subzones or the refractive power of the outer subzones is in a range from −2.5 to 2.5 dioptres around the largest of the main refractive powers.

14. The multifocal lens according to claim 1, wherein at least one inner or outer subzone is subdivided into partial zones of which averaged refractive powers correspond to the refractive power of the respective subzone.

15. The multifocal lens according to claim 1, wherein the area of each main zone is less than π mm².

16. The multifocal lens according to claim 1, wherein the area of each main zone is less 2π/3 mm².

17. The multifocal lens according to claim 1, wherein said area ratio is 50:50.

18. The multifocal lens according to claim 1, wherein the lens has 10 to 20 main zones.

19. The multifocal lens according to claim 1, wherein all subzones in combination form a diffraction grating which generates three main refractive powers of the lens by diffraction.

20. The multifocal lens according to claim 8, wherein all subzones in combination form a diffraction grating which generates the at least three main refractive powers of the lens by diffraction, and wherein the far refractive power is generated by the negative first diffraction order of the lens.
